(19) United States
(12) Patent Application Publication
(10) Pub. No.: US 2025/0284400 A1
(43) Pub. Date: Sep. 11, 2025

(54) READ CACHING FOR A SUBSEQUENT READ OPERATION

(71) Applicant: Microchip Technology Incorporated, Chandler, AZ (US)

(72) Inventors: Nian Niles YANG, Mountain View, CA (US); Srinivas YELISETTI, Fremont, CA (US); Pitamber SHUKLA, San Jose, CA (US)

(21) Appl. No.: 18/985,001

(22) Filed: Dec. 17, 2024

Related U.S. Application Data
(60) Provisional application No. 63/562,256, filed on Mar. 6, 2024.

(51) Int. Cl. G06F 3/06

(52) U.S. Cl. CPC G06F 3/0611; G06F 3/0659; G06F 3/0679

(57) ABSTRACT

In some implementations, a storage device may receive, from a host device, a first read command that indicates a first logical address for data stored on the storage device. The storage device may translate the first logical address to a local address of the storage device. The storage device may store an indication of a link between the first logical address and the local address on a random access memory (RAM) of the storage device. The storage device may receive a second read command that indicates a second logical address for stored data on the storage device. The storage device may identify a match between the first logical address and the second local address. The storage device may provide the data to the host device based at least in part on the match and the link between the first logical address and the local address.

### CROSS-REFERENCE TO RELATED APPLICATION

This patent application claims priority to Provisional Patent Application No. 63/562,256, filed on Mar. 6, 2024, and entitled “READ CACHING FOR A SUBSEQUENT READ OPERATION.” The disclosure of the prior application is considered part of and is incorporated by reference into this patent application

### FIELD

The present disclosure generally relates to storing one or more pieces of information from a previous read operation to improve latency of a subsequent read operation on a storage device. For example, a storage device (e.g., a controller of the storage device) may store the information within random access memory (RAM) of the storage device. The information may include data from the previous read operation or a translation from a logical address to a physical address associated with the data. The storage device may use the information to omit one or more operations associated with the subsequent read operation, and improve latency and a quality of service (QOS), based at least in part on storing the one or more pieces of information.

### BACKGROUND

A non-volatile memory device may include a storage device (e.g., a memory device) that may store and retain data without external power supply. One example of a non-volatile memory device is a negative-and (NAND) flash memory device.

The storage device may store data at various physical locations of the storage device. For example, the storage device may store data at one or more wordlines across multiple bitlines within the storage device. To access data stored on the storage device, a host device may provide a read command to the storage device. The read command may indicate a host logical address (e.g., a host logical block address (HLBA)) associated with the data. The storage device may convert (e.g., translate) the host logical address to a local logical address (e.g., flash logical block address (FLBA)). The storage device may then convert the local logical address to a local physical address (e.g., physical block address (PBA)). The storage device may then perform a read operation (e.g., sensing) at the physical address, perform any error correction, and then send data to the host device.

### SUMMARY

In some implementations, a method performed by a storage device includes receiving, from a host device, a first read command that indicates a first logical address for data stored on the storage device. The method also includes translating the first logical address to a local address of the storage device. The method also includes storing an indication of a link between the first logical address and the local address. The method also includes receiving a second read command that indicates a second logical address for data stored on the storage device. The method also includes identifying a match between the first logical address and the second logical address. The method also includes providing the data to the host device based at least in part on the match and the link between the first logical address and the local address.

In some implementations, a system comprises a storage device and a controller associated with the storage device. The controller may receive, from a host device, a first read command that indicates a first logical address for data stored on the storage device. The controller may store the first logical address and the data on a random access memory (RAM) associated with the storage device. The controller may receive a second read command that indicates a second logical address for stored data on the storage device. The controller may identify a match between the first logical address and the second logical address. The controller may provide the data to the host device from the RAM based at least in part on the match.

In some implementations, a computer program product comprises one or more computer readable storage media and program instructions collectively stored on the one or more computer readable storage media. The program instructions comprise program instructions to receive, from a host device, a first read command that indicates a first logical address for data stored on the storage device. The program instructions comprise program instructions to translate the first logical address to a physical address of the storage device; program instructions to store, on a RAM of the storage device, an indication of a link between the first logical address and the physical address. The program instructions comprise program instructions to receive a second read command that indicates a second logical address for stored data on the storage device. The program instructions comprise program instructions to identify a match between the first logical address and the second logical address. The program instructions comprise program instructions to perform a read operation at the physical address based at least in part on the match and the link between the first logical address and the physical address.

### BRIEF DESCRIPTION OF THE DRAWINGS

FIGS. 1 and 2 are diagrams of examples of read caching for a subsequent read operation described herein.

FIGS. 3 and 4 are diagrams of example components of one or more devices of FIG. 1 or 2.

FIGS. 5-7 are flowcharts of example processes associated with read caching for a subsequent read operation described herein.

### DETAILED DESCRIPTION

The following detailed description of example implementations refers to the accompanying drawings. The same reference numbers in different drawings may identify the same or similar elements.

To access data stored on the storage device, a host device may provide a read command to the storage device. The read command may indicate a host logical address (e.g., a host logical block address (HLBA)) associated with the data. The storage device may convert (e.g., translate) the host logical address to a local logical address (e.g., flash logical block address (FLBA)). The storage device may then convert the local logical address to a local physical address (e.g., physical block address (PBA)). The storage device may then perform a read operation (e.g., sensing) at the physical address, perform any error correction, and then send data to the host device.

If the host device provides a subsequent read command that requests the data at the same host logical address, the storage device again converts the host logical address to the local logical address, again converts the local logical address to the local physical address, and again performs a read operation at the local physical address. In this way, the storage device may repeat one or more operations that were previously performed, which repetition may cause latency in read commands and may negatively affect a quality of service (QOS) metric. Additionally, or alternatively, by repeating the operations, the storage device may consume resources that may otherwise be used to improve operations of the storage device. For example, by repeating the operations, resources of the storage device may be used to perform FLBA-PBA translation, increase flash controller channel traffic, and perform error correction code decoding decisions, among other examples.

Implementations described herein address issues with repeating the operations described above. For example, in some aspects described herein, a storage device (e.g., a controller of the storage device) may receive a first read command that indicates a first logical address stored on the storage device. The storage device may translate the first logical address to a local address of the storage device. For example, the storage device may convert the first logical address (e.g., a host logical address) to a local logical address and convert the local logical address to a local physical address. The term “local address” may refer to either of the local logical address or the local physical address. In some aspects, the storage device may read (e.g., sense or decode) data stored at the local address and send the data to the host device.

The storage device may store an indication of a link between the first logical address and the local address (e.g., a link between the host logical block address and the physical block address). For example, the storage device may store the indication of the link on a random-access memory (RAM), such as a synchronous dynamic RAM (SDRAM) of the storage device or a buffer RAM (BRAM) of the storage device (e.g., RAM of the controller). In some aspects, the storage device may further store the data from the first read command within the RAM of the storage device (e.g., the same RAM as the link or a different RAM). In some aspects, the data is stored along with an indication that links the data to the first logical address or the local address (e.g., the flash logical block address, or the physical block address).

The storage device may receive a second read command that indicates a second logical address for data stored on the storage device. The storage device may identify a match between the first logical address and the second logical address. For example, the second logical address may be the same as the first logical address, may be linked to the first logical address via an intermediate identifier, or may include one or more blocks (e.g., a subset of blocks) within the first logical address, among other examples.

Based at least in part on identifying the match, the storage device may use the indication of the first logical address and the local address to omit one or more operations associated with a read operation, which may reduce latency, conserve resources, or improve a QoS. For example, the storage device may use a link between the first logical address (e.g., the host logical block address) and a local address (e.g., the physical block address) to omit an operation associated with translating the second logical address to a local logical address or an operation associated with translating the local logical address to a physical block address. In some examples where the storage device stores the data associated with the first read command within RAM, the storage device may identify the data based at least in part on the link and send the data to the host device without performing a sensing or decoding operation on the physical block location.

After reading the RAM or reading the physical location (e.g., with omission of one or more translation operations), the storage device may provide the data to the host device based at least in part on the match and the link between the first logical address and the local address.

In some aspects, the storage device may store one or more read operation details (e.g., NAND details), such as a target, logical unit number (LUN), block, or page associated with the first read command. When a subsequent (e.g., next) read request is received, a microcode may compare current read request details with the previous read operation details. If a match occurs, the microcode may initiate a data transfer without issuing a page read command. In some examples, initiating the data transfer without issuing the page read command may reduce latency by 50 microseconds to 75 microseconds per read operation.

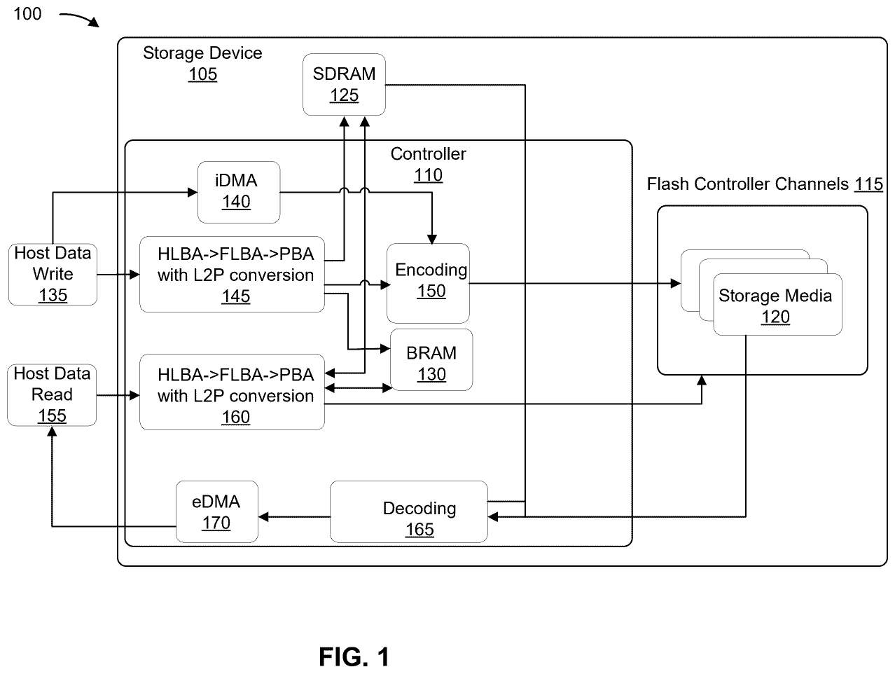

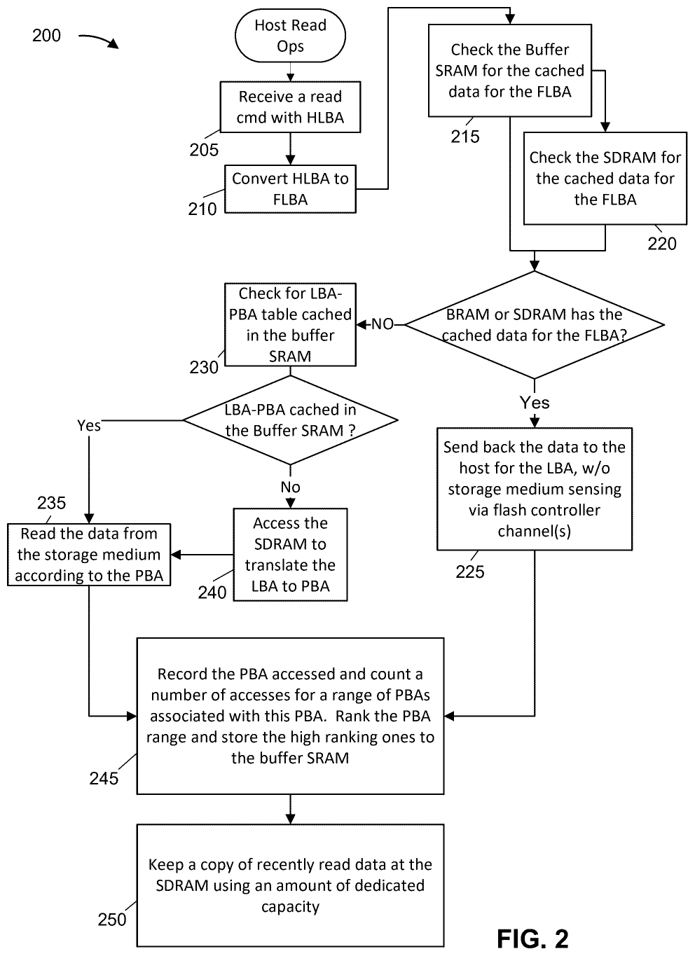

FIG. 1 is a diagram of an example 100 of a device performing writing of multi-level cell data described herein. Example 100 describes components and operations associated with a storage device 105. In some aspects, the storage device 105 may include a solid state drive (SSD) or another type of storage device. As shown in FIG. 1, the storage device 105 may include a controller 110, flash controller channels 115 that include storage media 120, and synchronous dynamic random access memory (SDRAM) 125. The controller 110 may also include BRAM 130. In some aspects, the SDRAM 125 may provide a relatively large amount of storage (e.g., gigabytes of storage) to be accessed by the controller 110 to operate the storage device 105. In some aspects, the BRAM 130 may also provide a relatively small amount of storage (e.g., less than the SDRAM). The BRAM 130 may include static read only memory (SRAM). Subsequent references to SRAM (e.g., in connection with FIG. 2) may refer to the BRAM 130. In some aspects, the flash controller channels 115 may be used to store a relatively large amount of data (e.g., terabytes of storage). The storage device 105 may store host data on the storage media 120.

As shown by reference number 135, the storage device 105 may receive host data for a write operation. For example, a host (e.g., a host device not shown) may provide the host data with a command to write to a storage medium. As shown by reference number 140, the storage device 105 may process the host data via an ingress direct memory access (iDMA) operation in preparation for storage to the storage media 120. An iDMA operation may provide the host data to a later stage of the write operation (e.g., the encoding operation 150 described below) as a direct data transfer to memory without involving a central processing unit (CPU).

The storage device 105 may identify a host logical block address (HLBA) associated with the host data by which the host may reference the host data in a future read operation. As shown by reference number 145, the storage device may convert the HLBA to a flash logical block address (FLBA) or other local logical block address, and then may link the FLBA to a physical block address (PBA) using logical to physical (L2P) conversion. In this way, the host may send a static address associated with the host data, the storage device 105 may link the address known to the host to an address known to the storage device (the FLBA), and may link the address known to the storage device to a physical address of the storage medium at which the host data is to be stored. The storage device 105 may store the links between the HLBA, the FLBA, and the PBA in the SDRAM 125 or in the BRAM 130.

In some aspects, the host data may be moved within a storage medium of the storage media 120 or between a first storage medium and a second storage medium of the storage media 120, which the storage device 105 may note in the link between the FLBA and the physical location. In this way, the HLBA does not need to be updated when the host data is moved to a new PBA.

As shown in FIG. 1, the controller 110 may provide an indication of the link between the HLBA and one or more of the FLBA, or the PBA to one or more of the SDRAM 125 or the BRAM 130. For example, the SDRAM 125 or the BRAM 130 may store a link between the HLBA (or other host logical address) and the PBA (or other local address associated with the storage medium 120). In some aspects, the SDRAM 125 or BRAM 130 may store the link for a quantity of read requests (e.g., configured in firmware or other configuration information) or for an amount of time (e.g., configured in firmware or other configuration information), among other examples.

As shown by reference number 150, the storage device 105 may perform encoding (e.g., error correction code encoding) on the host data as provided by the iDMA operation. For example, the controller 110 may include an error code encoder that performs the error correction code encoding. In some aspects, the error correction code encoding may include adding redundancy, parity bits, or other information that can later be used to identify errors in the host data when read from the storage medium. The encoding may include a linear error correction code encoding or low density parity check (LDPC) encoding. The storage device 105 may provide the host data, after encoding, via the flash controller channels 115 to write on the storage media 120 at a physical location as determined in the L2P conversion.

As shown by reference number 155, the storage device 105 may receive a request from a host to read data from the storage medium. For example, the host may provide a request to read the host data that was provided for writing in connection with reference number 135. As shown by reference number 160, the storage device 105 may perform HLBA to FLBA to PBA conversion. For example, the controller 110 may identify the HLBA in the request and may provide the HLBA to the SDRAM 125, the BRAM 130 to identify the FLBA or the PBA. The SDRAM 125 or the BRAM 130 may have stored the link between the HLBA to the PBA in connection with a previous read or write command. In some aspects, the BRAM 130 is an internal memory of the controller 110 with less storage capacity than the SDRAM 125 (e.g., based at least in part on limited space and cost of being on the controller 110). In some aspects, the BRAM 130 may be more expensive than the SDRAM 125 (e.g., based at least in part on being internal to the controller 110), may have a lower storage capacity than the SDRAM 125, and may have lower latency than the SDRAM 125.

Once the PBA is identified in connection with the request, the controller 110 may read the storage media 120 via the flash controller channels 115 at the PBA. For example, the controller 110 may obtain sensing results at the PBA. As shown by reference number 170, the controller 110 may perform decoding on data read from the storage media 120.

Data decoded at reference number 170 may include data that was provided to the storage media 120 after encoding at reference number 150. Decoding at reference number 170 may include LDPC decoding or linear error correction code decoding, among other examples.

Before or after decoding the data associated with the read command of reference number 155, the storage device 105 may store the data in the SDRAM 125 or the BRAM 130. In some aspects, the controller 110 may send the data to the SDRAM 125 or the BRAM 130 in anticipation of a subsequent request for the same data. For example, the controller 110 may anticipate the subsequent request based at least in part on timing (e.g., recently requested data is most likely to be requested by a subsequent request) or data type (e.g., data associated with a data stream, data associated with an active application, or data associated with system operations, among other examples, may be most likely to be requested in a subsequent request), among other examples. In some aspects, a data type may be indicated along with the host data (e.g., in metadata appended to the host data). In some aspects, the data type may be determined by accumulated statistics or prior knowledge of the storage device 105.

In some aspects, the SDRAM 125 or the BRAM 130 may store the data along with an indication of the address of the data. For example, the data may be stored with an indication of the PBA, the HLBA, or the FLBA, among other examples. In some aspects, the SDRAM 125 or the BRAM 130 may store a lookup table to identify the data within the SDRAM 125, the BRAM 130. In some aspects, the SDRAM 125 or the BRAM 130 may store data associated with multiple read requests and may be configured to provide any of the data stored thereon if a subsequent read request requests the same data as a previous read request having data stored thereon.

As shown by reference number 170, the controller 110 may perform egress direct memory access (eDMA) to isolate the host data of the request for sending to the host. For example, an eDMA controller (e.g., eDMA engine) may perform eDMA to isolate data to be delivered to the host in association with the read request. In some aspects, the host may send multiple read requests to the storage device 105 and eDMA may be used to isolate a portion of read data that is to be provided to the host for a specific read request. In some examples, the eDMA controller may have access to a number of the flash controller channels 115. In some aspects, the flash controller channels 115 may be used in parallel so the eDMA may perform multiple commands via multiple flash controller channels 115.

After the first read request is performed, the storage device 105 may receive a second (e.g., subsequent) request from the host to read data from the storage medium. In response to the second request, the storage device 105 may perform the HBLA-FLBA-PBA conversion described in connection with reference number 160. However, to perform the conversion from HBLA to PBA, the controller 110 may lookup the HLBA in the SDRAM 125 or the BRAM 130 to determine if a direct link from the HLBA to the PBA is stored or valid. The direct link may be valid based at least in part on a time since the direct link was created (e.g., the direct link may expire after a time or after a threshold number of read requests is reached). If the direct link from the HLBA to the PBA is stored and valid, the controller 110 may skip a conversion from the HLBA to the FLBA and send the read request to the flash controller channels 115 to read the storage media 120 at the PBA.

As shown by reference number 165, the storage device (e.g., as instructed by the controller 110) may perform decoding on the data. During the decoding, the controller 110 may perform error correction, remove redundancies, and order components of the data for delivery to the host. As shown by reference number 170, the storage device 105 may process the host data via an egress direct memory access (eDMA) operation in preparation for delivery to the host. An eDMA may provide the host data to the host as a direct data transfer to the host without involving a central processing unit (CPU).

In some aspects of a second host data read request, the controller 110 may provide the HLBA, the FLBA, or the PBA to the SDRAM 125 or the BRAM 130 to determine if the data is already stored in RAM from a previous read operation. In some aspects, the HLBA may match stored data in the SDRAM 125 or the BRAM 130 based at least in part on the HLBA, the FLBA, or the PBA matching the stored data. For example, the stored data may be tagged with the HLBA directly, or may be tagged with the FLBA or the PBA, which may match the HLBA after performing at least a portion of an L2P conversion. In some aspects, a tag of the stored data may be indicated in the SDRAM 125 or the BRAM 130 (e.g., in a lookup table or with the data). If the controller 110 determines that the data is stored in the SDRAM 125 or the BRAM 130, the controller may skip sending the read request with the PBA to the flash controller channels 115 and may instead request the data from the SDRAM 125 or the BRAM 130. The controller 110 may then provide the data to the host device (e.g., after eDMA at 170). In some aspects, the controller 110 may decode the data at reference number 165 (e.g., if the data was stored at the SDRAM 125 before decoding) or may skip decoding if the data was decoded at reference number 165 before storing at the SDRAM 125 or the BRAM 130.

The number and arrangement of components shown in FIG. 1 are provided as an example.

FIG. 2 is a diagram of an example 200 of read caching for a subsequent read operation described herein. The operations described in connection with example 200 may be performed by one or more of a controller (e.g., of a non-volatile memory device) or a host device, among other examples. Although examples may be described in connection with FIG. 2 as a solid state device (SSD) or a NAND device, other storage devices are intended to be interchangeable in the context of the described aspects and examples. In the context of FIG. 2, a storage device may have previously performed a read operation and stored information associated with the previous read operation within RAM of the storage device for later access. The operations shown in FIG. 2 relate to a subsequent read command that may use the stored information to reduce latency, conserve resources, or improve QoS associated with the subsequent read command and associated read operation.

As shown in FIG. 2, and by reference number 205, a storage device may receive a read command with HBLA (a logical address) from a host device. As shown by reference number 210, the storage device may convert the logical address (e.g., HLBA) to a local logical block address (e.g., FLBA).

As shown by reference number 215, the storage device may (e.g., instead of or as part of the conversion of the logical address to the local address, such as a local logical address or local physical address) check the buffer SRAM (e.g., BRAM 130) for the cached data for the FLBA. For example, the storage device may check the buffer SRAM to see if information from a previous read command may support omission of one or more elements of the read operation. For example, the storage device may skip a read operation based at least in part on the data already being cached at the buffer SRAM.

As shown by reference number 220, the storage device (e.g., the controller) may check an SDRAM for cached data to determine whether requested data is already available in the SDRAM (at block 220). In some examples, the storage device may use the logical address indicated in the read command (e.g., the HLBA) to check for a match within the SDRAM or the buffer SRAM (e.g., in connection with reference number 215). For example, the data may be stored in the buffer SRAM or the SDRAM along with an indication of a link to the logical address (e.g., as an identifier associated with the data).

If the data is already available at the SRAM or the SDRAM, As shown by reference number 225, the storage device may send the data to the host device for the LBA without performing a storage medium sensing operation via one or more flash controller channels. In this way, the storage device may send the data with reduced latency and may free up resources of the controller channels to perform other operations.

As shown by reference number 230, if the data is not stored in the SRAM (a relatively small storage capacity) or the SDRAM, the storage device may check for an LBA-PBA table cached at the buffer SRAM (e.g., the BRAM 130). For example, the storage device may provide the LBA (e.g., HLBA) to the buffer SRAM to see if a storage structure includes translation information associated with the LBA.

As shown by reference number 235, if the translation is stored in the buffer SRAM, the storage device may read the data from the storage medium (e.g., using one or more of a sensing operation or decoding operation) associated with the physical address. The storage device may read the data according to the PBA without first translating the logical address to a local logical address (e.g., using a lookup table at the SDRAM).

As shown by reference number 240, if the translation is not stored in the buffer SRAM, the storage device may access the SDRAM to translate the LBA to the PBA. In this case, the storage device may convert the logical address to a local logical address and then to a physical address before reading the data from the physical address.

As shown by reference number 245, the storage device may record a PBA accessed (in the read operation associated with reference number 205) and count a number of accesses for a range of PBAs associated with this PBA. The storage device may rank the PBA range and store the high ranking PBA ranges to the buffer SRAM. In some aspects, the storage device may store the PBA with the logical address (e.g., host logical address) associated with the read command. In some aspects, the storage device may determine a ranking (e.g., a priority) of the read command and associated logical address based at least in part on a quantity of requests that indicate the same logical address or range of addresses. In some aspects, the storage device may store the translation from the logical address to the physical address based at least in part on the priority.

As shown by reference number 250, the storage device may keep a copy of recently read data at the SDRAM using an amount of dedicated capacity. In some aspects, the storage device may store (e.g., record) the data based at least in part on being the most recently read data. In some aspects, the storage device may store additional data based at least in part on being withing a set amount of most-recently read data. In some aspects, the storage device may store the data based at least in part on the priority of the PBA. The data stored at the SDRAM may be decoded before being stored at the SDRAM. In some aspects, the data stored at the SDRAM may replace older data (the older data removed to free up resources for the data).

The number and arrangement of components shown in FIG. 2 are provided as an example.

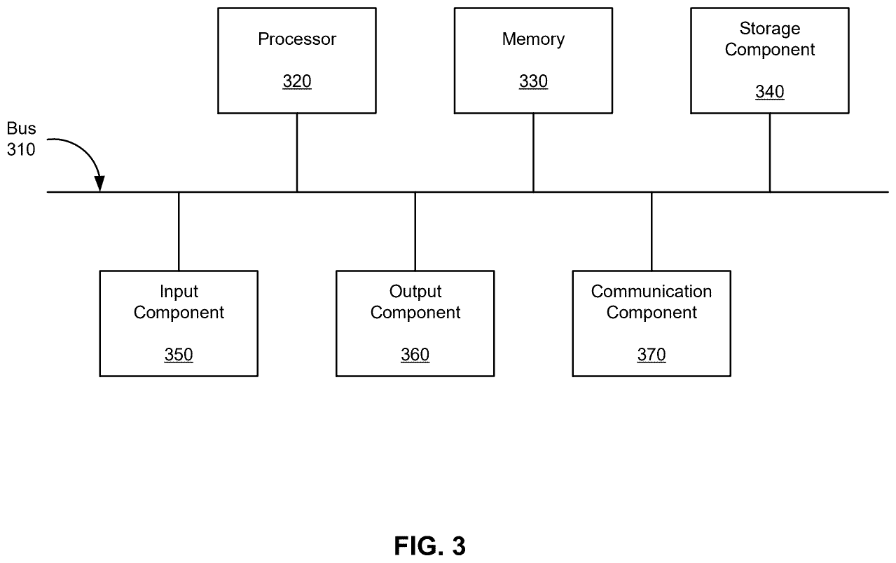

FIG. 3 is a diagram of example components of a device 300, which may correspond to one or more devices of FIG. 1, such as a storage device 105 or a controller 110. In some implementations, the controller or the host device may include one or more devices 300 and one or more components of device 300. As shown in FIG. 3, device 300 may include a bus 310, a processor 320, a memory 330, a storage component 340, an input component 350, an output component 360, and a communication component 370.

Bus 310 includes a component that enables wired or wireless communication among the components of device 300. Processor 320 includes a central processing unit, a graphics processing unit, a microprocessor, a controller, a microcontroller, a digital signal processor, a field-programmable gate array, an application-specific integrated circuit, or another type of processing component. Processor 320 is implemented in hardware, firmware, or a combination of hardware and software. In some implementations, processor 320 includes one or more processors capable of being programmed to perform a function. Memory 330 includes a random access memory, a read only memory, or another type of memory (e.g., a flash memory, a magnetic memory, or an optical memory).

Storage component 340 stores information or software related to the operation of device 300. For example, storage component 340 may include a hard disk drive, a magnetic disk drive, an optical disk drive, a solid state disk drive, a compact disc, a digital versatile disc, or another type of non-transitory computer-readable medium. Input component 350 enables device 300 to receive input, such as user input or sensed inputs. For example, input component 350 may include a touch screen, a keyboard, a keypad, a mouse, a button, a microphone, a switch, a sensor, a global positioning system component, an accelerometer, a gyroscope, or an actuator. Output component 360 enables device 300 to provide output, such as via a display, a speaker, or one or more light-emitting diodes. Communication component 370 enables device 300 to communicate with other devices, such as via a wired connection or a wireless connection. For example, communication component 370 may include a receiver, a transmitter, a transceiver, a modem, a network interface card, or an antenna.

Device 300 may perform one or more processes described herein. For example, a non-transitory computer-readable medium (e.g., memory 330 or storage component 340) may store a set of instructions (e.g., one or more instructions, code, software code, or program code) for execution by processor 320. Processor 320 may execute the set of instructions to perform one or more processes described herein. In some implementations, execution of the set of instructions, by one or more processors 320, causes the one or more processors 320 or the device 300 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 3 are provided as an example. Device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

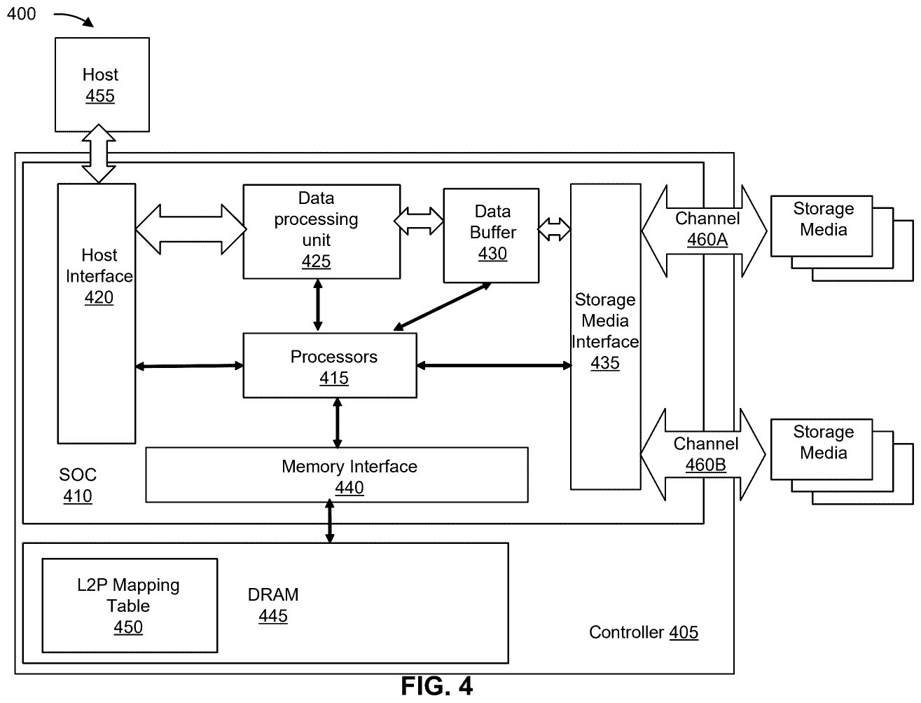

FIG. 4 is a diagram of example components of a storage device 400, which may correspond to one or more devices of FIG. 1, FIG. 2 or FIG. 3.

As shown in FIG. 4, the storage device 400 may include a controller 405 (e.g., an SSD controller). The controller 405 may include a system on chip (SOC) 410. The SOC 410 may perform computing or processing operations for the controller 405. The SCO may include one or more processors 415 that control, command, or observe operations at one or more other components of the SOC 410. The one or more processors 415 may be communicably coupled too one or more of a host interface 420, a data processing unit 425, a data buffer 430 a storage medium interface 435, or a memory interface 440.

The host interface 410 may be configured to communicate with a host device (e.g., host device 455 described below). The DPU 425 may manage data flow between the host interface 410 and storage media. The DPU 425 may further include a functional block that is responsible for managing data operations, such as reading, writing, error correction, or formatting. The DPU 425 may perform tasks such as page and block management (e.g., organization of data within storage media), bad block management, garbage collection, error correction and detection (e.g., using error correction codes or soft bit processing), data transformation (e.g., address mapping from host addresses to physical addresses, compression and decompression, or scrambling, among other examples), encryption and decryption, or power management associated with data operations, among other examples.

The data buffer 430 is a pipeline data buffer for the data transition. The data buffer 430 may include a temporary storage area used to transfer or process data between the storage media and a host system. The memory interface 440 is an interface between controller 410 and external DDR or DRAM, which may be used to temporarily hold the data. The memory interface 440 may provide an interface between the SOC 410 and the DRAM 445 to facilitate transfers of information. For example, the memory interface 440 may support requests to access a logical to physical (L2P) mapping table to identify a physical location of data requested by the host device, or to provide mapping information for storage in the L2P mapping table.

The controller 405 may further include DRAM 445. The DRAM 445 may locally store information that is available on demand at the controller 405 for operations of the controller 405. For example, the DRAM 445 may store an L2P mapping table 450 that maps logical locations of data and physical locations of data on connected storage media. In this way, the controller 405 may have access to mapping information for locating data on the connected storage media based at least in part on an indication associated with host data when written.

The host interface 420 may provide an interface for communicating with a host 455. For example, the host interface 420 may receive an access request or data for storage on connected storage media. In some aspects, the host interface 420 may provide data to the host after reading the data on from the connected storage media.

The storage media interface 435 may communicate via one or more channels 460 (e.g., 460A and 460B) with one or more connected storage media 465 (e.g., 465A and 465B). For example, the controller 405 may perform or initiate a read or write operation at a physical location of a storage media device 465.

The number and arrangement of components shown in FIG. 4 are provided as an example.

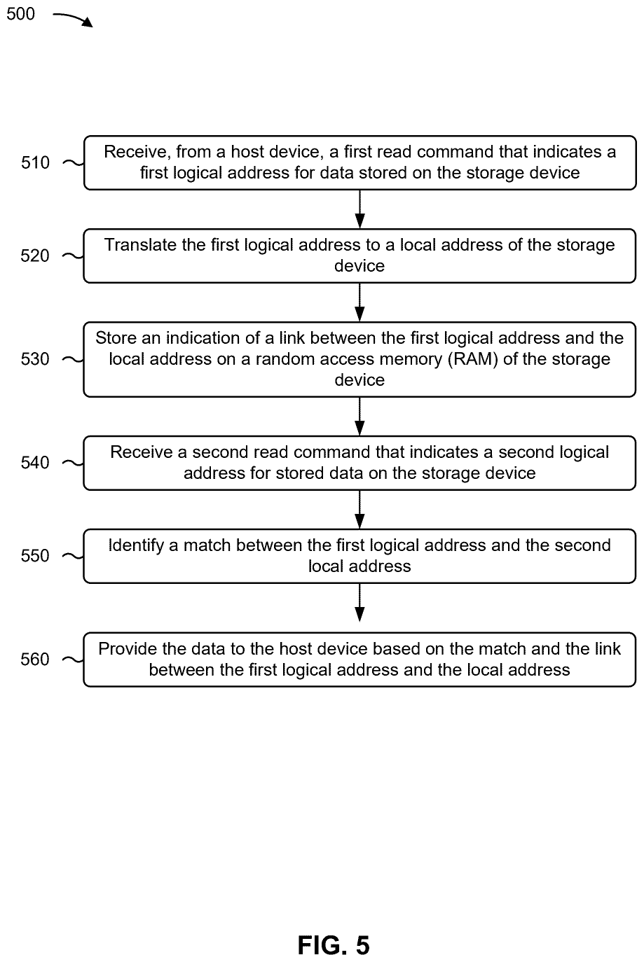

FIG. 5 is a flowchart of an example process 500 associated with read caching for a subsequent read operation field brief description of the drawings. In some implementations, one or more process blocks of FIG. 5 may be performed by a storage device. In some implementations, one or more process blocks of FIG. 5 may be performed by another device or a group of devices separate from or including the storage device, such as a controller. Additionally, or alternatively, one or more process blocks of FIG. 5 may be performed by one or more components of device 300, such as processor 320, memory 330, storage component 340, input component 350, output component 360, or communication component 370. In some aspects, one or more process blocks of FIG. 5 may be performed by one or more components of device 400, such as controller 405, SOC 410, or DRAM 445, or other component devices (e.g., a BRAM of the controller 405).

As shown in FIG. 5, process 500 may include receiving, from a host device, a first read command that indicates a first logical address for data stored on the storage device (block 510). For example, the storage device may receive, from a host device, a first read command that indicates a first logical address for data stored on the storage device, as described above (e.g., in connection with reference numbers 155 or 205).

As further shown in FIG. 5, process 500 may include translating the first logical address to a local address of the storage device (block 520). For example, the storage device may translate the first logical address to a local address of the storage device, as described above, (e.g., in connection with reference number 145, 160, or 240).

As further shown in FIG. 5, process 500 may include storing an indication of a link between the first logical address and the local address on a random access memory (RAM) of the storage device (block 530). For example, the storage device may store an indication of a link between the first logical address and the local address on a RAM of the storage device, as described above (e.g., in connection with reference numbers 125, 145, or 160).

As further shown in FIG. 5, process 500 may include receiving a second read command that indicates a second logical address for stored data on the storage device (block 540). For example, the storage device may receive a second read command that indicates a second logical address for stored data on the storage device, as described above (e.g., in connection with reference numbers 155 or 205).

As further shown in FIG. 5, process 500 may include identifying a match between the first logical address and the second local address (block 550). For example, the storage device may identify a match between the first logical address and the second local address, as described above (e.g., in connection with reference numbers 125, 160, or 230).

As further shown in FIG. 5, process 500 may include providing the data to the host device based at least in part on the match and the link between the first logical address and the local address (block 560). For example, the storage device may provide the data to the host device based at least in part on the match and the link between the first logical address and the local address, as described above. In some implementations, the data may be provided from a RAM of a controller. In some implementations, the data may be provided from the storage device (e.g., in connection with reference number 235).

Process 500 may include additional implementations, such as any single implementation or any combination of implementations described below or in connection with one or more other processes described elsewhere herein.

In some implementations, the local address comprises a logical block address associated with a physical block address of the data.

In some implementations, process 500 includes storing the data on the RAM based at least in part on receiving the first read command, wherein providing the data to the host device comprises providing the data from the RAM.

In some implementations, providing the data from the RAM comprises providing the data from the RAM without first performing, after receiving the second read command, a read operation at a physical location associated with the local address of the storage device.

In some implementations, storing the data on the RAM comprises storing a set of data associated with a set of one or more most-recent read commands.

In some implementations, storing the data on the RAM comprises storing the data after performing error correction on the data.

In some implementations, storing the indication of the link comprises storing a set of links between logical addresses and local addresses associated with a set of one or more most-recent read commands.

In some implementations, in the match comprises one or more of an identical match between the first logical address and the second logical address, or a match by the first logical address and the second logical address to one or more intermediate identifiers.

In some implementations, process 500 includes performing a read operation at a physical location of the storage device associated with the local address based at least in part on the match, wherein providing the data to the host device comprises providing the data based at least in part on the read operation.

In some implementations, translating the first logical address to the local address comprises converting the first logical address to a local logical address, and converting the local logical address to the local address.

In some implementations, performing the read operation at the physical location of the storage device comprises performing the read operation without first performing, after receiving the second read command, a first conversion from the first logical address to a local logical address and a second conversion from the local logical address to the local address.

In some implementations, process 500 includes providing, before receiving the second read command, the data to the host device based at least in part on the first read command, wherein receiving the second read command comprises receiving the second read command based at least in part on a failure associated with providing the data to the host device based at least in part on the first read command.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

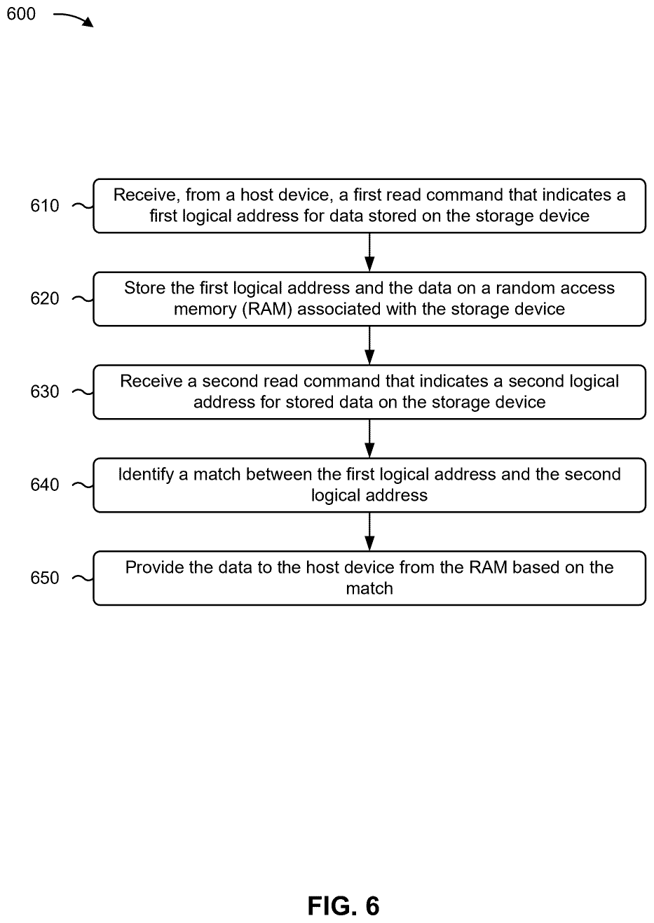

FIG. 6 is a flowchart of an example process 600 associated with read caching for a subsequent read operation field brief description of the drawings. In some implementations, one or more process blocks of FIG. 6 may be performed by a storage device. In some implementations, one or more process blocks of FIG. 6 may be performed by another device or a group of devices separate from or including the storage device, such as a controller. Additionally, or alternatively, one or more process blocks of FIG. 6 may be performed by one or more components of device 300, such as processor 320, memory 330, storage component 340, input component 350, output component 360, or communication component 370. In some aspects, one or more process blocks of FIG. 5 may be performed by one or more components of device 400, such as controller 405, SOC 410, or DRAM 445, or other component devices (e.g., a BRAM of the controller 405).

As shown in FIG. 6, process 600 may include receiving, from a host device, a first read command that indicates a first logical address for data stored on the storage device (block 610). For example, the storage device may receive, from a host device, a first read command that indicates a first logical address for data stored on the storage device, as described above (e.g., in connection with reference numbers 155 or 205).

As further shown in FIG. 6, process 600 may include storing the first logical address and the data on a RAM associated with the storage device (block 620). For example, the storage device may store the first logical address and the data on a RAM associated with the storage device, as described above (e.g., in connection with reference numbers 155 or 205).

As further shown in FIG. 6, process 600 may include receiving a second read command that indicates a second logical address for stored data on the storage device (block 630). For example, the storage device may receive a second read command that indicates a second logical address for stored data on the storage device, as described above (e.g., in connection with reference numbers 155 or 205).

As further shown in FIG. 6, process 600 may include identifying a match between the first logical address and the second logical address (block 640). For example, the storage device may identify a match between the first logical address and the second logical address, as described above (e.g., in connection with reference numbers 125, 160, or 230).

As further shown in FIG. 6, process 600 may include providing the data to the host device from the RAM based at least in part on the match (block 650). For example, the storage device may provide the data to the host device from the RAM based at least in part on the match, as described above (e.g., in connection with reference number 235).

Process 600 may include additional implementations, such as any single implementation or any combination of implementations described below or in connection with one or more other processes described elsewhere herein.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

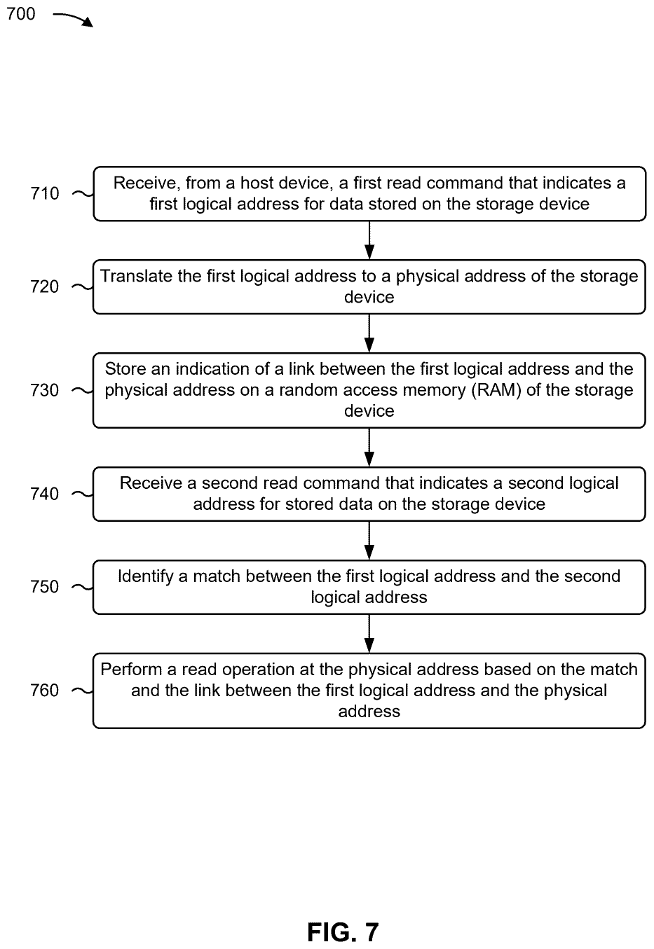

FIG. 7 is a flowchart of an example process 700 associated with read caching for a subsequent read operation field brief description of the drawings. In some implementations, one or more process blocks of FIG. 7 may be performed by a storage device. In some implementations, one or more process blocks of FIG. 7 may be performed by another device or a group of devices separate from or including the storage device, such as a controller. Additionally, or alternatively, one or more process blocks of FIG. 7 may be performed by one or more components of device 300, such as processor 320, memory 330, storage component 340, input component 350, output component 360, or communication component 370. In some aspects, one or more process blocks of FIG. 5 may be performed by one or more components of device 400, such as controller 405, SOC 410, or DRAM 445, or other component devices (e.g., a BRAM of the controller 405).

As shown in FIG. 7, process 700 may include receiving, from a host device, a first read command that indicates a first logical address for data stored on the storage device (block 710). For example, the storage device may receive, from a host device, a first read command that indicates a first logical address for data stored on the storage device, as described above (e.g., in connection with reference numbers 155 or 205).

As further shown in FIG. 7, process 700 may include translating the first logical address to a physical address of the storage device (block 720). For example, the storage device may translate the first logical address to a physical address of the storage device, as described above (e.g., in connection with reference number 145, 160, or 240).

As further shown in FIG. 7, process 700 may include storing an indication of a link between the first logical address and the physical address on a RAM of the storage device (block 730). For example, the storage device may store an indication of a link between the first logical address and the physical address on a RAM of the storage device, as described above (e.g., in connection with reference numbers 125, 145, or 160).

As further shown in FIG. 7, process 700 may include receiving a second read command that indicates a second logical address for stored data on the storage device (block 740). For example, the storage device may receive a second read command that indicates a second logical address for stored data on the storage device, as described above (e.g., in connection with reference numbers 155 or 205).

As further shown in FIG. 7, process 700 may include identifying a match between the first logical address and the second logical address (block 750). For example, the storage device may identify a match between the first logical address and the second logical address, as described above (e.g., in connection with reference numbers 125, 160, or 230).

As further shown in FIG. 7, process 700 may include performing a read operation at the physical address based at least in part on the match and the link between the first logical address and the physical address (block 760). For example, the storage device may perform a read operation at the physical address based at least in part on the match and the link between the first logical address and the physical address, as described above (e.g., in connection with reference numbers 160, 120, or 235).

Process 700 may include additional implementations, such as any single implementation or any combination of implementations described below or in connection with one or more other processes described elsewhere herein.

Although FIG. 7 shows example blocks of process 700, in some implementations, process 700 may include additional blocks, fewer blocks, different blocks, or differently arranged blocks than those depicted in FIG. 7. Additionally, or alternatively, two or more of the blocks of process 700 may be performed in parallel.

In some implementations, a method performed by a storage device includes receiving, from a host device, a first read command that indicates a first logical address for data stored on the storage device. The method includes translating the first logical address to a local address of the storage device. The method includes storing an indication of a link between the first logical address and the local address on a random access memory (RAM) of the storage device. The method includes receiving a second read command that indicates a second logical address for stored data on the storage device. The method includes identifying a match between the first logical address and the second local address. The method includes providing the data to the host device based at least in part on the match and the link between the first logical address and the local address.

In some implementations, a system includes a controller, of a non-volatile memory device, to receive, from a host device, a first read command that indicates a first logical address for data stored on the storage device. The controller is to translate the first logical address to a local address of the storage device. The controller is to store an indication of a link between the first logical address and the local address on a RAM of the storage device. The controller is to receive a second read command that indicates a second logical address for stored data on the storage device. The controller is to identify a match between the first logical address and the second local address. The controller is to provide the data to the host device based at least in part on the match and the link between the first logical address and the local address.

In some implementations, a computer program product comprises one or more computer readable storage media, and program instructions collectively stored on the one or more computer readable storage media. The program instructions comprise program instructions to receive, from a host device, a first read command that indicates a first logical address for data stored on the storage device. The program instructions comprise program instructions to translate the first logical address to a local address of the storage device. The program instructions comprise program instructions to store an indication of a link between the first logical address and the local address on a RAM of the storage device. The program instructions comprise program instructions to receive a second read command that indicates a second logical address for stored data on the storage device. The program instructions comprise program instructions to identify a match between the first logical address and the second local address. The program instructions comprise program instructions to provide the data to the host device based at least in part on the match and the link between the first logical address and the local address.

In some implementations, a method performed by a storage device includes receiving, from a host device, a first read command that indicates a first logical address for data stored on the storage device. The method includes storing the first logical address and the data on a RAM associated with the storage device. The method includes receiving a second read command that indicates a second logical address for stored data on the storage device. The method includes identifying a match between the first logical address and the second logical address. The method includes providing the data to the host device from the RAM based at least in part on the match.

In some implementations, a method performed by a storage device includes receiving, from a host device, a first read command that indicates a first logical address for data stored on the storage device. The method includes translating the first logical address to a physical address of the storage device. The method includes storing an indication of a link between the first logical address and the physical address on a random access memory (RAM) of the storage device. The method includes receiving a second read command that indicates a second logical address for stored data on the storage device. The method includes identifying a match between the first logical address and the second logical address. The method includes performing a read operation at the physical address based at least in part on the match and the link between the first logical address and the physical address.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

As used herein, the term “component” is intended to be broadly construed as hardware, firmware, or a combination of hardware and software. It will be apparent that systems or methods described herein may be implemented in different forms of hardware, firmware, or a combination of hardware and software. The actual control hardware or software code used to implement these systems or methods is not limiting of the implementations. Thus, the operation and behavior of the systems or methods are described herein without reference to specific software code-it being understood that software and hardware can be used to implement the systems or methods based at least in part on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims or disclosed in the specification, these combinations are not intended to limit the disclosure of various implementations. In fact, many of these features may be combined in ways not specifically recited in the claims or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein is to be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “or,” unless explicitly stated otherwise (e.g., if used in combination with “either” or “only one of”).

What is claimed is:

1. A method comprising:
establishing a set of multiple banks of platform configuration registers (PCRs) associated with a virtual trusted platform module (TPM), respective banks of PCRs being associated with different applications (dep—applications may include different tenants);
receiving a first request, associated with a first application, to perform a first PCR operation (via a library application that includes a state of the device with the request);
performing the first PCR operation within a first bank of PCRs associated with the first application;
receiving a second request, associated with a second application, to perform a second PCR operation (via a library application that includes a state of the device with the request); and
performing the second PCR operation within a second bank of PCRs associated with the second application.

2. The method of claim 1, wherein the local address comprises a logical block address associated with a physical block address of the data.

3. The method of claim 1, comprising storing the data on random-access memory (RAM) based at least in part on receiving the first read command,
wherein providing the data to the host device comprises providing the data from the RAM.

4. The method of claim 3, wherein providing the data from the RAM comprises:
providing the data from the RAM without first performing, after receiving the second read command, a read operation at a physical location associated with the local address of the storage device.

5. The method of claim 3, wherein storing the data on the RAM comprises:
storing a set of data associated with a set of one or more most-recent read commands.

6. The method of claim 3, wherein storing the data on the RAM comprises:
storing the data after performing error correction on the data.

7. The method of claim 1, wherein storing the indication of the link comprises:
storing a set of links between logical addresses and local addresses associated with a set of one or more most-recent read commands.

8. The method of claim 1, wherein the match comprises one or more of:
an identical match between the first logical address and the second logical address, or
a match by the first logical address and the second logical address to one or more intermediate identifiers.

9. The method of claim 1, comprising performing a read operation at a physical location of the storage device associated with the local address based at least in part on the match,
wherein providing the data to the host device comprises providing the data based at least in part on the read operation.

10. The method of claim 9, wherein translating the first logical address to the local address comprises:
converting the first logical address to a local logical address; and
converting the local logical address to the local address.

11. The method of claim 9, wherein performing the read operation at the physical location of the storage device comprises:
performing the read operation without first performing, after receiving the second read command, a first conversion from the first logical address to a local logical address and a second conversion from the local logical address to the local address.

12. The method of claim 1, further comprising providing, before receiving the second read command, the data to the host device based at least in part on the first read command,
wherein receiving the second read command comprises receiving the second read command based at least in part on a failure associated with providing the data to the host device based at least in part on the first read command.

13. A system comprising:
a storage device; and
a controller, associated with the storage device, to:
receive, from a host device, a first read command that indicates a first logical address for data stored on the storage device;
store the first logical address and the data on a random access memory (RAM) associated with the storage device;
receive a second read command that indicates a second logical address for stored data on the storage device;
identify a match between the first logical address and the second logical address; and
provide the data to the host device from the RAM based at least in part on the match.

14. The system of claim 13, wherein the controller is to store the data on the RAM based at least in part on receiving the first read command, and
wherein, to provide the data to the host device, the controller is to provide the data from the RAM.

15. The system of claim 13, wherein, to provide the data from the RAM, the controller is to:
provide the data from the RAM without first performing, after receiving the second read command, a read operation at a physical location associated with the local address of the storage device.

16. The system of claim 13, wherein the match comprises one or more of:
an identical match between the first logical address and the second logical address, or
a match by the first logical address and the second logical address to one or more intermediate identifiers.

17. A computer program product comprising:
one or more computer readable storage media, and program instructions collectively stored on the one or more computer readable storage media, the program instructions comprising:
program instructions to receive, from a host device, a first read command that indicates a first logical address for data stored on the storage device;
program instructions to translate the first logical address to a physical address of the storage device;
program instructions to store, on a random access memory (RAM) of the storage device, an indication of a link between the first logical address and the physical address;
program instructions to receive a second read command that indicates a second logical address for stored data on the storage device;
program instructions to identify a match between the first logical address and the second logical address; and
program instructions to perform a read operation at the physical address based at least in part on the match and the link between the first logical address and the physical address.

18. The computer program product of claim 17, wherein, to store the indication of the link, the program instructions comprise:
program instructions to store a set of links between logical addresses and physical addresses associated with a set of one or more most-recent read commands.

19. The computer program product of claim 17, wherein, to translate the first logical address to the physical address, the program instructions comprise:
program instructions to convert the first logical address to a local logical address; and
program instructions to convert the local logical address to the physical address.

20. The computer program product of claim 17, wherein, to perform the read operation at the physical location of the storage device, the program instructions comprise:
program instructions to perform the read operation without first performing, after receiving the second read command, a first conversion from the first logical address to a local logical address.
